(19) United States
(12) Patent Application Publication
(10) Pub. No.: US 2026/0331542 A1
(43) Pub. Date: Oct. 22, 2026

(54) CONTROL METHOD FOR STARTING UP A FUEL CELL SYSTEM

(71) Applicant: AVL List GmbH, Graz (AT)

(72) Inventors: David WEINGRILL, Stallhofen (AT); Markus KOGLER-LICHTENEGGER, St.Stefan ob Stainz (AT); Emil VESTUM, Oslo (NO); Fredrik AARSKOG, Oslo (NO)

(73) Assignee: AVL List GmbH, Graz (AT)

(21) Appl. No.: 18/997,106

(22) PCT Filed: Jul. 20, 2023
(86) PCT No.: PCT/AT2023/060243

§ 371 Date: Jan. 20, 2025

(30) Foreign Application Priority Data
Jul. 21, 2022 (AT) A 50545/2022

(51) Int. Cl. H01M 8/04302; H01M 8/04537; H01M 8/04746; H01M 8/04858

(52) U.S. Cl. CPC H01M 8/04302; H01M 8/04559; H01M 8/04753; H01M 8/0488

(57) ABSTRACT

The present invention relates to a control method for starting up a fuel cell system after a standstill, with the steps: Supplying the anode supply gas to the anode supply section (12) and, at least temporarily, shutting off and/or throttling the cathode supply gas to the cathode supply section (14). According to the invention, the at least temporary shutting-off and/or throttling of the cathode supply gas is performed or continued until an open-circuit voltage (Uoc) has fallen back to or below a permissible threshold voltage (Uth); and a switch device (20) of an electrical connection between a fuel cell unit (10) and a DC voltage converter (30) is only closed after the open-circuit voltage (Uoc) has fallen back to or below the permissible threshold voltage (Uth).

The present invention relates to a control method for starting up a fuel cell system after a standstill, a corresponding control device and a computer program product.

In fuel cell systems for supplying a consumer with high-voltage power, for example in a stationary application or a powertrain with a large-dimensioned electric drive for a commercial vehicle or ship, the output voltage of the fuel cell stacks is usually increased or boosted by a DC voltage converter to the voltage level of a high-voltage supply for the consumer.

In full-load operation or within a predetermined operating range, for the sake of efficiency a voltage difference to be converted in the DC-DC voltage converter is designed to be low. In order to keep the voltage difference to be converted low, the output voltage of the fuel cell stacks under load must be designed to be relatively high, or close to the supply voltage of the consumer. In the case of fuel cell systems for the supply of high voltage, a maximum permissible operating voltage of the DC voltage converter on the low-voltage side forms a technical limitation in the design of the smallest possible voltage difference which can be converted efficiently in load operation. In the semiconductor-based power electronics of voltage converters, a permissible maximum operating voltage is approximately 1200 V according to the current state of the art.

When the fuel cell stacks are disconnected from the electrical load, for example when the fuel cell system is started up, these generate an open-circuit voltage which can exceed an output voltage under load and, in particular, the maximum operating voltage of the DC voltage converter. If this condition occurs during the start-up of the fuel cell system, the DC voltage converter would be damaged as soon as an electrical connection between the fuel cell stacks and the DC voltage converter is closed. Accordingly, there is a need for a technique for avoiding overvoltage damage to a DC voltage converter when a fuel cell system is started up in the high-voltage range.

On the other hand, fuel cell systems are known in the prior art that connect an artificial load or dummy load with the fuel cell stacks when an open-circuit voltage becomes very high in order to lower this and avoid an impairment of the service life of the cells due to excessively high voltages. In this context, it can be problematic if, when the fuel cell system is started up, not all cells around stacks are supplied uniformly or sufficiently with the fuel gas, especially if there is air in the system after a prolonged standstill, i.e. there is oxygen at both the cathode and the anode. If a load is applied in this state, in which a high open-circuit voltage can also be generated, polarity reversals or a reversal of the voltage potentials can occur in individual cells, with depletion of fuel. Even if these occur for a short time, these are considerably more harmful to the service life of the cells than transient high open-circuit voltages. Accordingly, there is also a need for a technique that reliably prevents the occurrence of such potential reversals in cells.

One object of the invention is to create a technique for starting up a fuel cell system in which it is possible to configure a higher output voltage of the fuel cell stacks under load, in particular a higher dimensioning of the output power, in which connection an open-circuit voltage of the fuel cell stacks can exceed a technically limited maximum operating voltage of the DC voltage converter. It is also an object of the invention to create a technique for starting up a fuel cell system that can both avoid overvoltage damage to a DC voltage converter and also reliably prevent the occurrence of harmful potential reversals in cells.

The above object is achieved by the control method with the features of claim 1. Further features and details of the invention are disclosed in the dependent claims, the description and the drawings.

According to the invention, a control method for starting up a fuel cell system after a standstill is provided. The system typically comprises at least one fuel cell stack with a cathode supply section for supplying a cathode supply gas, a cathode discharge section for discharging a cathode discharge gas, an anode supply section for supplying an anode supply gas and an anode discharge section for discharging an anode discharge gas; and a DC voltage converter for increasing the voltage between an output voltage of the fuel cell stack on a low-voltage side and a supply voltage of a high-voltage supply line on a high-voltage side; and a switch to open and close an electrical connection between the fuel cell stack and the DC voltage converter.

The control method according to the invention is characterised by the following steps: supplying the anode supply gas to the anode supply section; at least temporarily shutting off and/or throttling the cathode supply gas to the cathode supply section; monitoring an increasing open-circuit voltage of the fuel cell stack when the switch of the electrical connection is open. If the open-circuit voltage exceeds a predetermined permissible threshold voltage with respect to the DC voltage converter, the control method according to the invention further comprises, in particular, the steps of performing and/or continuing the at least temporary shutting-off and/or throttling of the cathode supply gas until the open-circuit voltage has fallen back to or below the permissible threshold voltage; and closing the switch of the electrical connection after the open-circuit voltage has dropped back to or below the permissible threshold voltage.

The invention thus provides for the first time the approach of providing for a shortage of oxygen during the start-up of the fuel cell system, and by means of this causing a reduction of the open-circuit voltage before the fuel cell stacks are connected to the DC voltage converter.

The invention is also based on the finding that, during a standstill of the fuel cell system, air penetrates into the system, or existing air in the cathode section also spreads or disseminates towards the anode section. Accordingly, when the fuel cell system is restarted after a standstill, there is always oxygen from the air remaining in the fuel cell stacks which can be used to start the electrochemical reaction until this is gradually consumed. If there is a shortage or consumption of oxygen in the fuel cell stacks due to a supply of fresh oxygen being shut off or the oxidation gas supply being significantly reduced compared to the fuel gas supply, the throughput of electrochemical reaction in the cells decreases and the open-circuit voltage is consequently lowered.

One advantage of the invention is that this measure allows the open-circuit voltage to be controlled after an increase when the fuel cell system is started up by limiting the oxygen, and to be lowered in a targeted manner before a connection with the DC voltage converter, so that overvoltage damage to the latter is prevented.

Another advantage of the invention is that an oversaturation of the fuel gas is achieved at the anode side, instead of a presence of oxygen at both the cathode and anode sides. This can safely prevent a potential reversal occurring on a cell as soon as the fuel cell stacks are connected to a load under an uneven fuel gas supply, as is the case in the prior art.

According to an advantageous aspect of the invention, the continuation of the at least temporary shutting-off and/or throttling of the cathode supply gas can comprise a shutting-off and/or throttling that starts with the supply of the anode supply gas. In this variant, the supply of the oxidation gas or air is not started from the outset until the fuel cell stacks are electrically connected. This means that the fuel cell system can be started up and put into operation as quickly as possible.

According to an alternative advantageous aspect of the invention, performing the at least temporary shutting-off and/or throttling of the cathode supply gas can comprise a shutting-off and/or throttling that starts as soon as the open-circuit voltage exceeds the permissible threshold voltage. This variant can be chosen for a system design in which the open-circuit voltage only occasionally exceeds critical values. This ensures that the gas supply is only throttled if this becomes necessary for the purpose of overvoltage protection.

According to an advantageous aspect of the invention based on this, the at least temporary shutting-off and/or throttling of the cathode supply gas can comprise a change in a throttling rate in response to the monitoring of the open-circuit voltage in relation to the permissible threshold voltage. This variant allows a more precise metering of the oxygen shortage at the cells in order to be able to control these even more effectively, on the one hand to ensure the electrochemical reaction from the beginning and, on the other hand, thereafter according to the development of the open-circuit voltage.

According to a specific advantageous aspect of the invention, the at least temporary shutting-off and/or throttling of the cathode supply gas can comprise an increase in the throttling rate in response to an exceeding of the open-circuit voltage in relation to the permissible threshold voltage. In this variant, a lower throttling of the oxidation gas can take place first, and in the event of critical voltage values a higher throttling, or a gradual change in the throttling rate can take place depending on a rate of increase of the open-circuit voltage.

According to another advantageous aspect of the invention, the DC voltage converter can have a capacitor or be connected to a capacitor which is configured to be charged and discharged in a controllable manner; and the method can further comprise the following step: pre-charging the capacitor before closing the switch of the electrical connection. In this way, the capacitor provides an electrical capacitance that can be charged and discharged via the DC voltage converter. These charging and discharging processes are in particular designed to be controllable.

According to the above advantageous aspect of the invention, the control method can include the following step with respect to the capacitor: starting the pre-charging of the capacitor after the open-circuit voltage falls below the permissible threshold voltage. The capacitor can have an electrical resistor, which can also be referred to as a pre-charge resistor, so that high currents, in particular current spikes, can be avoided or at least smoothed out when charging and discharging the capacitor. As soon as the anode of the fuel cell unit is supplied, the voltage increases. Pre-charging of the capacitor is then delayed until the voltage falls below the threshold value. Following the pre-charging, the switch device is closed. In this variant, the capacitor can only be used conditionally in cases where the open-circuit voltage assumes critical voltage values.

According to the above advantageous aspect of the invention, the capacitor can be connected to the high-voltage side of the DC voltage converter to pre-charge the capacitor on the high-voltage supply line.

Otherwise, according to the above advantageous aspect of the invention, the capacitor can be connected to the low-voltage side of the DC voltage converter to pre-charge the capacitor on the fuel cell stack.

According to an advantageous aspect of the invention, the permissible threshold voltage can be predetermined in relation to a technically dictated maximum operating voltage of the DC voltage converter on the low-voltage side.

The permissible threshold voltage can be predetermined as being below or equal to the maximum operating voltage of a silicon carbide (SIC) based semiconductor circuit of the DC voltage converter and/or preset within a range of 700 V to 900 V, preferably to or below approximately 800 V.

Alternatively, the upper threshold voltage can be predetermined as being below or equal to the maximum operating voltage of a gallium nitride (GaN) based semiconductor circuit of the DC/DC voltage converter and/or preset within a range of 1100 V to 1300 V, preferably to or below approximately 1200 V.

The subject matter of the invention also includes a control device for a fuel cell system and a computer program product by means of which the steps of the control method according to the invention can be implemented when starting up the fuel cell system.

Thus, the control device and the computer program product bring the same advantages as have been explained in detail with reference to the control method according to the invention.

Further advantages, features and details of the invention are explained in the following description, in which exemplary embodiments of the invention are described in detail with reference to the drawings. In each case schematically:

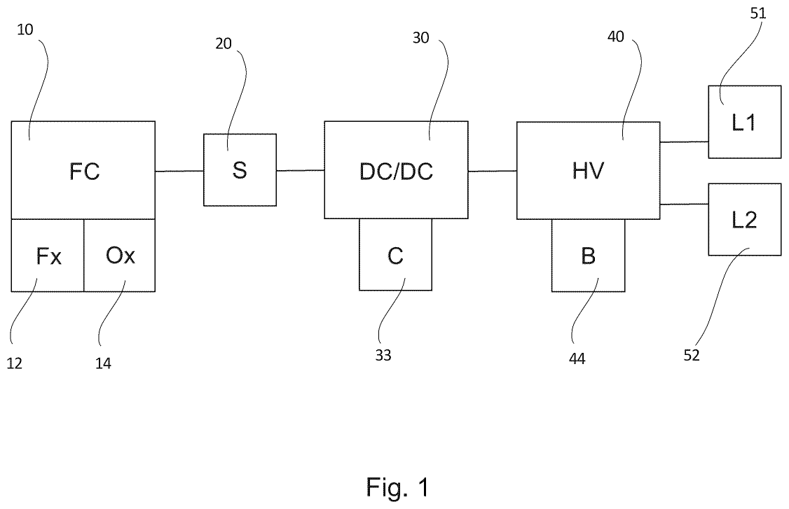

FIG. 1 shows a schematic block diagram of a section of a fuel cell system in the system context of which the control method according to the invention is implemented,

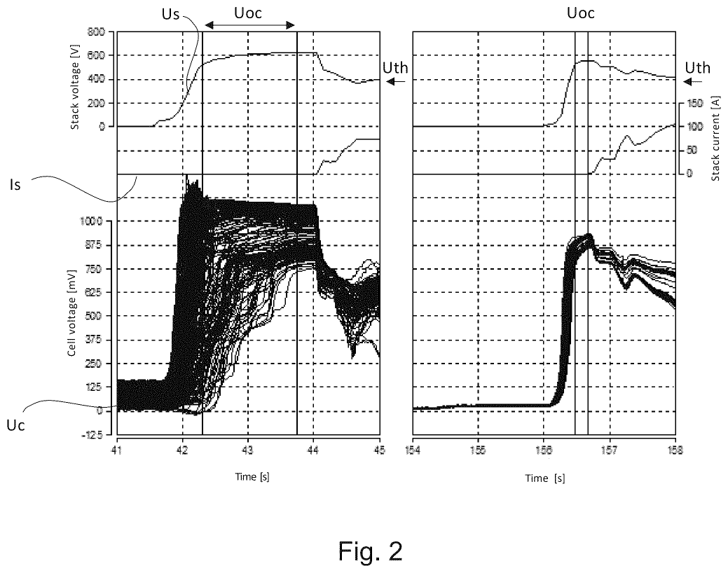

FIG. 2 shows a comparison of diagrams of the voltage and current curves during the start-up of fuel cell stacks with and without air at the anode supply section and when applying the control method according to the invention, and

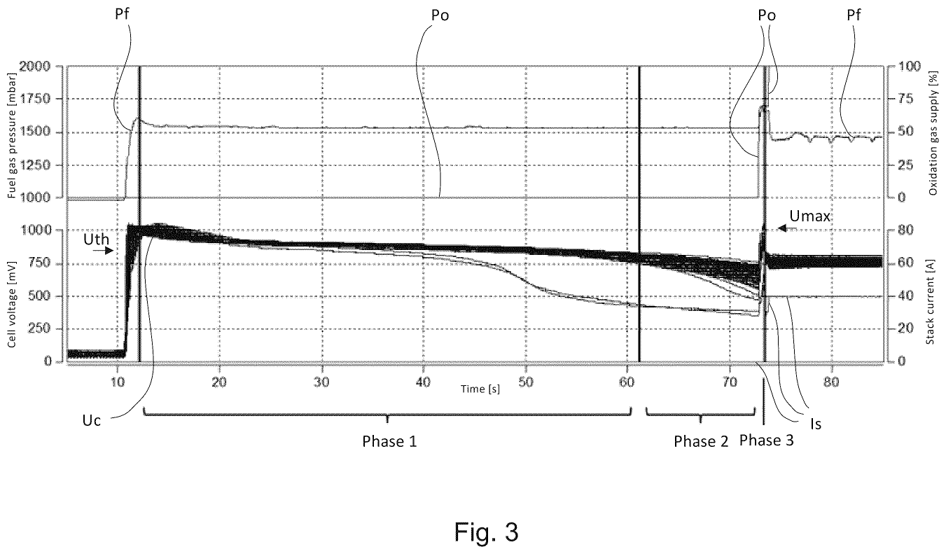

FIG. 3 shows a diagram of the voltage and current curves as well as gas supply parameters over individual phases of the control method according to the invention.

FIG. 1 shows a section of a fuel cell system that is relevant for the control method, which is represented schematically as a block diagram. The fuel cell system comprises a fuel cell unit 10 with fuel cell stacks, each of which has an anode section not shown in detail and a cathode section. The anode section of each fuel cell stack is connected to an anode supply section 12 for the supply of anode supply gas, which supplies a fuel gas (Fx), in particular hydrogen, in a known manner. The cathode section of each fuel cell stack 10 is connected to a cathode supply section 14 for the supply of cathode supply gas, which supplies an oxidation gas (Ox), in particular oxygenated air. In addition, the respective cathode section is connected to a cathode discharge section for discharging cathode exhaust gas, and the respective anode section is connected to an anode discharge section for discharging anode exhaust gas (not shown in detail). In the present embodiment, the fuel cell unit 10 is designed for large-scale power generation, for example a stationary or semi-stationary or nautical application, i.e. a self-sufficient building supply, or for propulsion systems for ships and other heavy-duty utility vehicles, including on-board electrical systems and consumers. The fuel cell unit 10 can be designed for a main operating point under load in a high-voltage range, for example around 750 V or around 1100 V.

The fuel cell unit 10 is used to generate electrical power for a high-voltage supply section 40 of the fuel cell system. The high-voltage supply section 40 supplies direct current power with a high supply voltage to consumers [connected to] a powertrain, an on-board electrical system or a supply network of a building. In the embodiment shown, a first load 51, e.g. representing an electric drive, and a second load 52, e.g. representing an air conditioning system, are connected to the high-voltage supply section 40 in order to draw generated power from the fuel cell unit 10. The high-voltage supply section 40 is also connected to a storage battery 44 which compensates for fluctuations of a dynamic load requirement between generation and consumption and stabilises a voltage level of the supply voltage.

A DC voltage converter 30 is provided between the fuel cell unit 10 and the high-voltage supply section 40. The DC voltage converter 30 serves as a voltage booster that raises a load-dependent varying output voltage of the fuel cell unit 10 to the supply voltage. For this purpose, the DC voltage converter 30 has a low-voltage side to which the generated power from the fuel cell unit 10 is supplied, and a high-voltage side that transmits the power onwards to the high-voltage supply section 40 at an increased voltage. Alternatively, a “buck/boost” design is also conceivable as a DC voltage converter 30, wherein similar voltages are applied on both sides. Such an embodiment is also covered by the present invention. Furthermore, the DC voltage converter 30 includes a capacitor 33 whose capacitance helps to smooth out a power-dependent fluctuation of the output voltage of the fuel cell unit 10 compared to the supply voltage of the high-voltage supply section 40 or to compensate for voltage and current spikes between the low-voltage side and the high-voltage side, which may for example occur during switching operations in electrical connections of the fuel cell system.

To allow variable voltage conversion, the DC voltage converter 30 also includes power electronics with transistors installed on a semiconductor made of silicon carbide (SIC) or gallium nitride (GaN). For technical reasons arising from a maximum reverse voltage between the band gaps of these semiconductor materials, there are limits to a maximum permissible operating voltage Umax which can be applied to the power electronics without damaging circuits. According to the current state of the art, the maximum permissible voltages for silicon carbide (SIC) and gallium nitride (GaN) semiconductor technology are around 800 V and 1200 V, respectively.

An electrical connection between the fuel cell unit 10 and the DC voltage converter 30 can be disconnected by a switch device 20. The switch device 20 is designed with a high-voltage-suitable switch technology, for example as a circuit breaker. The switch device 20 is disconnected, inter alia, during a standstill of the fuel cell system, during which the fuel cell unit 10 enters an idle state without a gas supply. Accordingly, when the fuel cell system is started up again after a standstill, the switch device 20 must be closed again before the generated power from the fuel cell unit 10 can be fed to the first load 51 and the second load 52.

FIG. 2 shows in two diagrams a comparison between parameters which result when fuel cell stacks are started up with (left) and without (right) air at the anode supply section and when using the control method according to the invention.

Depending on the design of the pipe, seal and valve technology in the fuel cell system, after a standstill of the fuel cell system of at least several hours, in particular as from a standstill of approximately one day, it can be assumed that air has penetrated into the entire fuel cell unit 10 or diffused through membranes. In other words, this means that air is not only present in the cathode section of the fuel cell stacks, but has also spread to the anode section.

When the fuel cell system is restarted, fuel gas is fed through the anode supply section 12 and oxidation gas is fed through the cathode supply section 14 to start the electrochemical reaction in the cells and ramp up power generation. In a conventional mode of operation, this is continued, whereby, even in a supply state in which air is still present on the cathode side and the anode side of the cells, a high open-circuit voltage Uoc occurs comparatively early, as can be seen from the upper voltage curve for the stack voltage Us and the lower group of voltage curves for the individual cell voltages Uc in the left-hand diagram of FIG. 2.

If the open-circuit voltage Uoc of the fuel cell unit 10 or a fuel cell stack exceeds a predetermined threshold voltage Uth of, for example, 400 V, a voltage limitation (also known as “voltage clipping”) is carried out in that a set stack current Is is dissipated at the fuel cell stack. This stack current Is, which is plotted by a curve in the middle area of the diagram, is dissipated by an artificial load (also called “dummy load”) or a resistor, which is electrically connected to the fuel cell stacks for this purpose, or by connection to the DC voltage converter 30, which dissipates power to the loads of the fuel cell system. This process is regulated appropriately in order to avoid long-term damage to the cells caused by high open-circuit voltages Uoc. As a result of the controlled power dissipation by means of the stack current Is, in the course shown, the open-circuit voltage Uoc decreases from approximately 600 V to the threshold voltage 400 V or, temporarily, below this.

As a result of an as yet incomplete supply or inhomogeneous dispersion of the fuel gas over all cells of the fuel cell stack during start-up, air may still be present in some cells, on both the cathode side and the anode side. In this state, which can be regarded as a partial fuel deficiency, there is a risk that, under the applied electrical load requirement for voltage limitation, a potential reversal will occur, with irreversible damage to the membrane of the cells. The wide spread of the lower group of voltage curves of the individual cell voltages Uc is an indication of an inhomogeneous distribution of fuel gas in the fuel cell stacks, whereby those voltage curves with a flatter course or the lowest voltage spike are specifically attributable to cells which are exposed to fuel deficiency and consequently to the risk of potential reversal when a load requirement is applied.

In the diagram on the right, the corresponding parameters of the stack voltage Us, individual cell voltages Uc and the stack current Is which occur when carrying out the control method according to the invention are plotted over the same time axis. When a supply of the fuel gas via the anode supply section 12 is started on restarting the fuel cell system, in this embodiment a supply of the oxidation gas via the cathode supply section 14 initially remains blocked in both cases (left and right in FIG. 2). The right-hand side of FIG. 2 shows a situation in which oxygen is not present either on the anode side or on the cathode side of the fuel cell unit 10. The voltage therefore only rises when the supply of the cathode side starts. In this case, the voltage limitation takes place. As can be seen from the upper voltage curve for the stack voltage Us and the lower group of voltage curves for the individual cell voltages Uc in the right-hand diagram of FIG. 2, slightly lower values of the open-circuit voltage Uoc result due to the lack of oxygen at the anode, whereby a spread in the lower group of voltage curves is considerably lower. The latter is attributable to the circumstance of a more homogeneous fuel gas distribution in the fuel cell stacks, since a saturation with fuel gas on the anode side is forced through the prior duration of an exclusive or at least predominant gas supply of fuel gas over the oxidation gas (in both cases shown in FIG. 2). As a result of the supply of oxygen in the fuel cell stack on the right-hand side of FIG. 2, the voltage increases.

FIG. 3 shows three phases of the control method according to the invention when starting up the fuel cell system. In a lower section, a group of cell voltages Uc of individual cells in a fuel cell stack and a stack current Is are plotted over the time axis, and the pressure of the fed fuel gas Pf and the pressure of the fed oxidation gas Po at the fuel cell stack are shown in an upper section.

Phase 1 corresponds substantially to the procedure of the control method described earlier in connection with FIG. 2. However, due to a different dimensioning of the fuel cell system, the open-circuit voltage values are higher than in FIG. 1. Together with the pressure Pf of the opened fuel gas supply, the open-circuit voltage Uoc in the system of FIG. 2 rises to over 1000 V, whereby a maximum permissible operating voltage Umax of the associated DC voltage converter 30 on the low-voltage side is approximately 1000 V, and a threshold voltage Uth predetermined in relation to this is set at approximately 800 V.

After approximately 10 seconds of start-up time on the time axis, the fuel gas supply is started and phase 1 begins, whereupon the open-circuit voltage Uoc increases rapidly due to an increase in the electrochemical reaction in the cells with the consumption of the oxygen in the fuel cell stacks. Without dissipating any power, the open-circuit voltage Uoc remains at a high level between 1000 V and 800 V over a period of phase 1. Due to the depletion of the oxygen, the electrochemical reaction in the cells decreases, so that, during a waiting period of up to 60 seconds, the open-circuit voltage Uoc gradually decreases to approximately 800 V. Although this waiting period requires a certain delay in the start-up of the fuel cell system, and the cells remain at a high open-circuit voltage Uoc during this time, weighing up the risks, also considered in the long term, this circumstance represents a lower damage potential than a potential reversal, avoided by these means, which would be directly associated with irreversible damage to cells.

From the point where the cell voltages UC drop from the level of an open-circuit voltage Uoc to the threshold voltage Uth, charging of the capacitor 33 of the DC voltage converter 30 is also begun in the following, optional, phase 2. By using the capacitor 33 together with a resistor for the charging and discharging process, the likelihood of occurrence of a voltage spike on the low-voltage side of the DC voltage converter 30 during a switching operation for electrical connection can be reduced and in this way the capacitor 33 can be protected.

At the end of phase 2, the oxidation gas supply is opened, as marked by the vertically rising curve Po of the oxidation gas pressure, and immediately afterwards the switch device 20 is actuated to connect the fuel cell unit 10 to the DC voltage converter 30. This results in a further increase in the open-circuit voltage Uoc of the fuel cell unit 10, which can however be controlled through the previously effected reduction to a certain voltage difference below the maximum permissible operating voltage Umax of the DC voltage converter 30 and a rapid controlled sequence of the actions of starting the oxidation gas supply and closing the switch device 20.

Depending on the configuration and control of a charging circuit of the capacitor 33, in particular if the capacitor 33 is charged via a charging circuit to the low-current side of the DC voltage converter 30 from a stack current Is that is dissipated from the fuel cell unit 10 by a fuel cell stack, the open-circuit voltage Uoc can be further reduced in this way. The capacitor 33 is in particular arranged on the low-voltage side. However, an arrangement on the high-voltage side is also conceivable, whereby the pre-charging is guaranteed by appropriate interconnection. Thereafter, due to the resulting higher voltage difference, an exceeding of the maximum permissible operating voltage Umax of the DC voltage converter 30 when the switch device 20 is closed can be prevented even more reliably.

Phase 3 substantially represents the beginning of the fully ramped-up load-capable operating state of the fuel cell system, whereby at least the pressure of the fuel gas supply Pf at the fuel cell unit 10 is thereafter variably adjusted depending on the requested total power of the first load 51 and the second load 52 from the high-voltage supply section 40. Thus, an operating point of the power to be generated at a uniform voltage level is possible with the support of the variable voltage conversion of the DC voltage converter 30 and the storage battery 40.

In one embodiment, for the step of pre-charging the capacitor 33 of the DC voltage converter 30 in the control method, the capacitor 33 is connected to the high-voltage side instead of being connected to the low-voltage side. By means of a corresponding configuration of a charging circuit, the capacitor 33 is charged from the high-voltage supply section 40 or from the storage battery 44 and not from the fuel cell unit 10, so that the charging process can take place independently of a closure of the switch device 20. Charging on the high-voltage side can be accomplished in a more controlled manner and/or more quickly than from the side of the fuel cell unit 10.

In an alternative embodiment, the permissible threshold voltage Uth predetermined with respect to the DC voltage converter 30 is not designed to be below the technically dictated maximum operating voltage Umax of a semiconductor circuit of the power electronics in the DC voltage converter 30; rather, the permissible threshold voltage Uth corresponds substantially to the maximum operating voltage Umax.

In a device-related embodiment, the control method is carried out by a dedicated control device (not shown) which is connected, at least in a signal connection, to the relevant system components of the fuel cell system, i.e. to the fuel cell unit 10 including the anode supply section 12 and the cathode supply section 14, the switch device 20, the DC voltage converter 30 including capacitor 33 and a charging circuit thereof, the high-voltage supply section 40 including the storage battery 44 and the loads 51, 52, in particular with actuators, sensors and/or circuits thereof, in order to initiate or control the method steps.

In an alternative device-related embodiment, the control method is carried out by an external control device in a system environment of the fuel cell system (not shown) which is indirectly or directly connected to the relevant system components at least via the aforementioned signal connection, whereby the aforementioned dedicated control device or the control method is controlled by means of a computer program on the hardware of the external control device.

The above explanations of the embodiments describe the present invention exclusively in the context of examples.

### LIST OF REFERENCE SIGNS

10 fuel cell unit
12 anode supply section
14 cathode supply section
20 switch device
30 DC voltage converter
33 capacitor
40 high-voltage supply section
44 storage battery
51 first load
52 second load
Uoc open-circuit voltage
Uth threshold voltage
Umax maximum permissible operating voltage
Uc cell voltage
Us stack voltage
Is stack current
Pf fuel gas supply pressure
Po oxidation gas supply pressure

1. Control method for starting up a fuel cell system after a standstill, the fuel cell system comprising:
a fuel cell unit with fuel cell stacks, each comprising a cathode supply section for supplying a cathode supply gas, a cathode discharge section for discharging a cathode discharge gas, an anode supply section for supplying an anode supply gas and an anode discharge section for discharging an anode discharge gas; a DC voltage converter for increasing the voltage between an output voltage of the fuel cell unit on a low-voltage side and a supply voltage of a high-voltage supply section on a high-voltage side; and a switch device for opening and closing an electrical connection between the fuel cell unit and the DC voltage converter comprising the following steps:
supplying the anode supply gas to the anode supply section
at least temporarily shutting off and/or throttling the cathode supply gas to the cathode supply section;
monitoring an increasing open-circuit voltage (Uoc) of a fuel cell stack when the switch device of the electrical connection is open; and
if the open-circuit voltage (Uoc) exceeds a predetermined permissible threshold voltage (Uth) with respect to the DC voltage converter:
performing and/or continuing the least temporary shutting-off and/or throttling of the cathode supply gas until the open-circuit voltage (Uoc) has dropped back to or below the permissible threshold voltage (Uth); and
closing the switch device of the electrical connection after the open-circuit voltage (Uoc) has dropped back to or below the permissible threshold voltage (Uth).

2. Control method for starting up a fuel cell system according to claim 1, wherein the continuation of the at least temporary shutting-off and/or throttling of the cathode supply gas comprises a shutting-off and/or throttling that starts with the supply of the anode supply gas.

3. Control method for starting up a fuel cell system according to claim 1, wherein performing the at least temporary shutting-off and/or throttling of the cathode supply gas comprises a shutting-off and/or throttling that starts as soon as the open-circuit voltage (Uoc) exceeds the permissible threshold voltage (Uth).

4. Control method for starting up a fuel cell system according to claim 1, wherein the at least temporary shutting-off and/or throttling of the cathode supply gas comprises an increase in a throttling rate in response to an exceeding of the open-circuit voltage (Uoc) in relation to the permissible threshold voltage (Uth).

5. Control method for starting up a fuel cell system according to claim 1, wherein the at least temporary shutting-off and/or throttling of the cathode supply gas comprises a change in the throttling rate in response to the monitoring of the open-circuit voltage (Uoc) in relation to the permissible threshold voltage (Uth).

6. Control method for starting up a fuel cell system according to claim 1, wherein the DC voltage converter has a capacitor or is connected to a capacitor which is configured to be charged and discharged in a controllable manner; and the method further comprises the following step:
Pre-charging the capacitor before closing the switch device of the electrical connection.

7. Control method for starting up a fuel cell system according to claim 6, further comprising the following step:
Starting the pre-charging of the capacitor after the open-circuit voltage (Uoc) falls below the permissible threshold voltage (Uth).

8. Control method for starting up a fuel cell system according to claim 6, further comprising the following step:
Connecting the capacitor to the low-voltage side of the DC voltage converter to pre-charge the capacitor on the fuel cell unit.

9. Control method for starting up a fuel cell system according to claim 6, further comprising the following step:
Connecting the capacitor to the high-voltage side of the DC voltage converter to pre-charge the capacitor on the high-voltage supply section.

10. Control method for starting up a fuel cell system according to claim 1, wherein the permissible threshold voltage (Uth) is predetermined in relation to a technically dictated maximum operating voltage (Umax) of the DC voltage converter on the low-voltage side.

11. Control method for starting up a fuel cell system according to claim 10, wherein the permissible threshold voltage (Uth) is predetermined as being below or equal to the maximum operating voltage (Umax) of a silicon carbide (SIC) based semiconductor circuit of the DC voltage converter (30) and/or is preset within a range of 700 V to 900 V, preferably to or below approximately 800 V.

12. Control method for starting up a fuel cell system according to claim 10, wherein the permissible threshold voltage (Uth) is predetermined as being below or equal to the maximum operating voltage (Umax) of a gallium nitride (GaN) based semiconductor circuit of the DC/DC voltage converter and/or is preset within a range of 1100 V to 1300 V, preferably to or below approximately 1200 V.

13. Control device for controlling the fuel cell system and for carrying out the steps of the control method according to claim 1.

14. Computer program product comprising commands which, when the program is run on a computer or control device, cause this to carry out the control method according to claim 1.
